(19) United States
(12) Patent Application Publication
(10) Pub. No.: US 2023/0365265 A1
(43) Pub. Date: Nov. 16, 2023

(54) DE-ICING ELEMENT LIABLE TO BE EXPOSED TO ICE

(71) Applicants: Airbus Operations SAS, Toulouse (FR); Institut National des Sciences Appliquées de Toulouse (INSAT), Toulouse (FR); Centre National de la Recherche Scientifique (CNRS), Paris (FR); Université Toulouse III - Paul Sabatier (UT3), Toulouse (FR); Institut Supérieur de l'Aéronautique et de l'Espace (ISAE), Toulouse (FR); École nationale supérieure des Mines d'Albi - Carmaux (IMT Mines ALBI), Albi CT (FR)

(72) Inventors: Arnaud BOURHIS, Toulouse (FR); Younes RAFIK, Toulouse (FR); Valerian PALANQUE, Toulouse (FR); Valérie POMMIER BUDINGER, Toulouse (FR); Marc BUDINGER, Toulouse (FR); Brice SAUDEL, Toulouse (FR); Yves CLERGENT, Toulouse (FR); Philippe OLIVIER, Toulouse (FR)

(21) Appl. No.: 18/316,334

(22) Filed: May 12, 2023

(30) Foreign Application Priority Data
May 16, 2022 (FR) 2204625

(51) Int. Cl. B64D 15/16; B64D 15/12

(52) U.S. Cl. CPC B64D 15/16; B64D 15/12

(57) ABSTRACT

A de-icing element having a skin with a surface to be de-iced, at least one excitation actuator attached to the skin, the excitation actuator configured to excite the skin according to at least one predetermined vibration mode generating a deformation of the skin, the deformation of the skin comprising at least one antinode and one node. The skin having a characteristic thickness generally constant with, locally, at least one thickness variation that is localized according to the predetermined vibration mode or modes.

### CROSS-REFERENCES TO RELATED APPLICATIONS

This application claims the benefit of French Patent Application Number 2204625 filed on May 16, 2022, the entire disclosure of which is incorporated herein by way of reference.

### FIELD OF THE INVENTION

The present invention concerns a de-icing element liable to be exposed to ice.

### BACKGROUND OF THE INVENTION

Some surfaces of aircraft components, in particular leading edges such as an air intake of an engine nacelle, are liable to be exposed to ice and can therefore suffer the formation of ice that accumulates to form blocks of ice. These blocks of ice may disturb the correct functioning of the aircraft and it is therefore desirable to eliminate them.

There exist various systems for eliminating such blocks of ice. One solution consists in heating the leading edge to be de-iced to prevent or to eliminate the accumulation of ice. For example, it may be heated by an electrothermal device or by circulation of hot air from the engines in a space situated behind the leading edge. Another solution consists in installing a de-icing boot on the surface to be de-iced. This boot includes a membrane that is inflated with compressed air in order to break up the blocks of ice. A further solution consists in protecting a surface with a shield layer to which a high electrical current electromagnetic actuator applies shocks in order to detach the ice.

However, these standard solutions are not completely satisfactory. Indeed they can require high powers, induce temperatures incompatible with the use of certain materials, necessitate bulky power supplies, have an insufficient service life, require extensive maintenance, or degrade the aerodynamics of the aircraft.

### SUMMARY OF THE INVENTION

The present invention concerns a de-icing element including a skin having a surface to be de-iced.

According to the invention the de-icing element comprises at least one excitation actuator fixed to the skin, the excitation actuator being configured to excite the skin in at least one predetermined vibration mode generating deformation of the skin, the deformation of the skin including at least one antinode and one node, the skin having a characteristic thickness that is generally constant with at least one local thickness variation that is localized according to the predetermined vibration mode or modes.

Accordingly, thanks to the invention, a skin is available in which the variations of thickness enable the deformation of ice present on the skin to be rendered uniform when said skin is excited by the excitation actuator. This uniformity of the curvature of the skin avoids localization of the stresses in the ice in a small area and induces an enlargement of the mechanical stress zone. The benefit is therefore obtained of an increase in the usable stored elastic energy enabling de-icing of the surface to be de-iced. This renders uniform and also increases the rate of energy release at the level of the surface to be de-iced. These variations of thickness of the skin have the effect of improving the distribution and the transfer of energy from the skin to the ice located on the surface to be de-iced and therefore of improved de-icing.

Advantageously, the predetermined vibration mode or modes are resonance modes of the skin.

Preferably, the thickness variation or variations of the skin are localized at the level of the antinode or antinodes of the predetermined vibration mode or modes.

In a first embodiment the thickness variation or variations of the skin correspond to local increases in the thickness of said skin relative to the characteristic thickness.

In one particular implementation of this embodiment, the skin includes:
a main layer having a thickness equal to the characteristic thickness, and
one or more attached parts fixed to the main layer, the attached part or parts corresponding to the thickness variation or variations of the skin.

In another particular embodiment the thickness increase or increases of the skin have a boss shape comprising a central part in which the thickness of the skin is maximal and a peripheral part surrounding the central part, the central part having a greater stiffness than a stiffness of the peripheral part.

In a second embodiment the thickness variation or variations correspond to local thickness reductions of said skin relative to the characteristic thickness, said thickness reductions each comprising a bottom where the thickness of the skin is minimal.

In a variant embodiment, the excitation actuator is configured to excite the skin successively in at least two predetermined vibration modes, said predetermined vibration modes being complementary in terms of deformation and stress.

In another variant embodiment, the de-icing element includes at least one heat strip arranged on the skin at the level of at least one node of the predetermined vibration mode or modes, said heat strip being configured to generate heat for de-icing the surface to be de-iced of the skin at least at the level of the node or nodes to which it is fixed.

Moreover, the excitation actuator corresponds to preferably an electromagnetic actuator or a piezoelectric actuator.

Moreover, the excitation actuator is advantageously configured to excite the skin by vibrations, by shocks or by pulsed forces.

### BRIEF DESCRIPTION OF THE DRAWINGS

The appended figures will provide a clear understanding of how the invention may be reduced to practice. In these figures identical reference numbers designate similar elements.

FIG. 1 is a schematic cross-sectional view of a skin of rectangular blade shape including overthicknesses.

FIG. 2 is a schematic perspective view toward the surface to be de-iced of the skin from FIG. 1 excited in a particular vibration mode.

FIG. 3 is a schematic cross-sectional view of a skin of rectangular blade shape including cavities.

FIG. 4 is a schematic cross-sectional view of a skin of rectangular blade shape including cavities and provided with a membrane.

FIG. 5 is a schematic perspective view toward the surface to be de-iced of a skin of plate shape including overthicknesses.

FIG. 6 is a perspective view toward the surface opposite the surface to be iced of the skin from FIG. 5.

FIG. 7 is a schematic cross-sectional view of a particular overthickness and a view toward the surface opposite the surface to be de-iced of said overthickness.

FIG. 8 is a schematic cross-sectional view of another particular overthickness and a view toward the surface opposite the surface to be de-iced of said overthickness.

FIG. 9 is a schematic and partial view in longitudinal section of an air intake of an aircraft engine nacelle including a de-icing element in accordance with one particular embodiment.

FIG. 10 is a partial perspective view of the de-icing element equipping the air intake of the engine nacelle from FIG. 9.

FIG. 11 is a view toward the surface to be de-iced of a skin excited in a first vibration mode complementary to a second vibration mode (FIG. 12).

FIG. 12 is a view toward the surface to be de-iced of a skin excited in a second vibration mode complementary to the first vibration mode (FIG. 11).

FIG. 13 is a view toward the surface to be de-iced of a skin including heat strips excited in a particular vibration mode.

FIG. 14 is a view toward the surface to be de-iced of a skin excited in a particular vibration mode including strips with elasticity different from the rest of the skin.

FIG. 15 is a perspective view of an aircraft including a de-icing element corresponding to an engine nacelle air intake lip.

### DETAILED DESCRIPTION OF THE PREFERRED EMBODIMENT

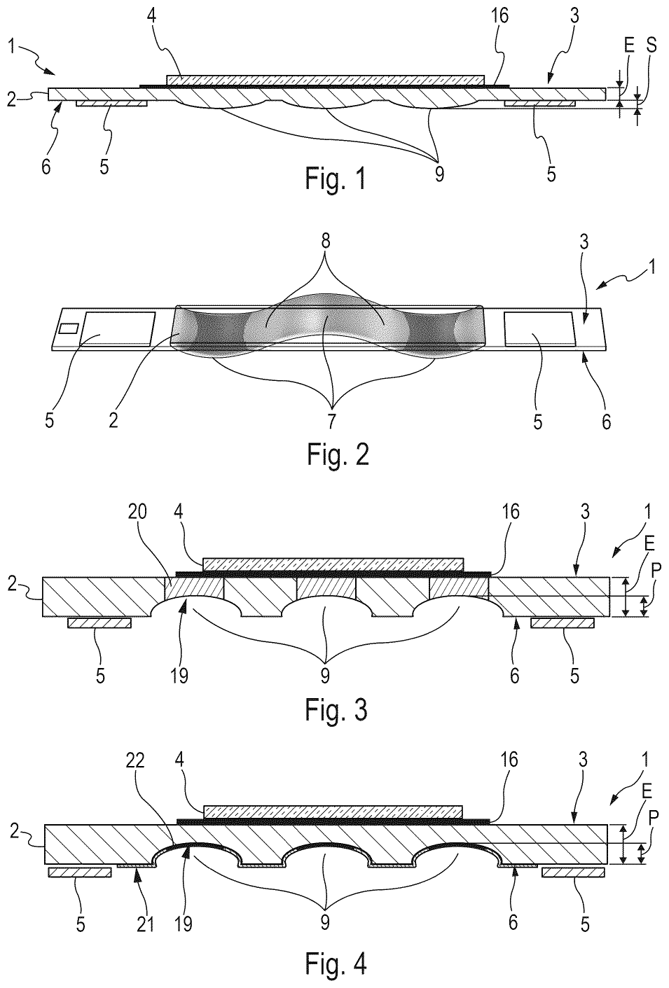

The de-icing element 1, particular embodiments of which are represented in FIGS. 1 to 15, is an element that can be mounted on highly varied devices or systems. At least a part the de-icing element 1 is subject to the formation (or deposition) of ice. By “ice” is meant layers or blocks of ice that may in particular take the form of a plurality of superposed layers.

The de-icing element 1 is particular in that it includes a skin configured to eliminate this ice as described in the remainder of the description.

The de-icing element 1 may be used in varied fields, in particular on devices or systems including blade elements. For example, the de-icing element 1 may correspond to a blade element of an aircraft propeller or a ship propeller or to a blade element of a wind turbine or a helicopter rotor.

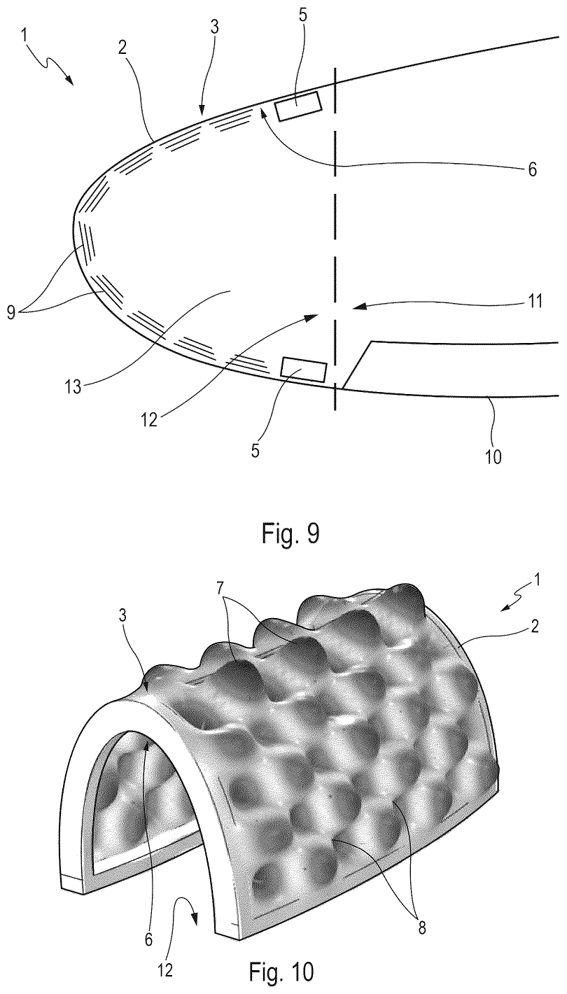

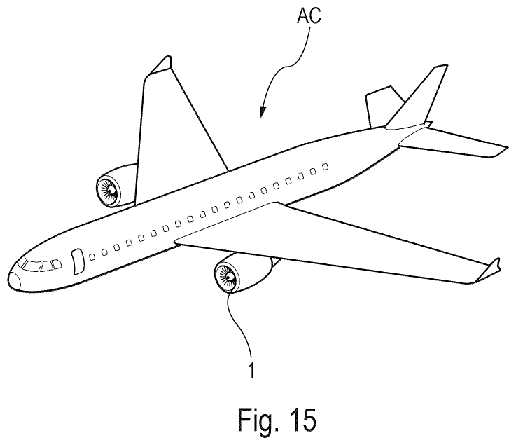

In a manner that is not limiting, the de-icing element 1 is particularly suitable for de-icing certain parts of an aircraft AC (FIG. 15), for example a transport airplane. It may correspond to any part of the aircraft AC having at least one surface to be de-iced such as an exposed surface on the outside of the aircraft AC that is subject to the formation of ice. For example, it may be a leading edge of the aircraft AC such as a leading edge of a wing or an engine nacelle air intake lip, as represented in FIG. 9, FIG. 10 and FIG. 15. It may equally be another standard element of the aircraft AC, for example a control surface such as an aileron.

The invention is particularly suitable for elements including smooth surfaces to be de-iced. A smooth surface corresponds to a surface without projecting shapes or elements. However, these elements may include any type of surface adapted to be excited mechanically as described hereinafter.

The de-icing element 1 includes a skin 2 having a generally constant characteristic thickness E. The skin 2 has a surface 3 to be de-iced (FIG. 1 to FIG. 10). By “generally constant” it is meant that the thickness varies by less than 10%, or less than 5%, or less than 1%. The surface 3 to be de-iced corresponds to a surface of the de-icing element 1 on which ice can accumulate in the form of at least one layer 4 of ice. The surface 3 to be de-iced may in particular correspond to a face of the de-icing element 1 directly exposed on the outside of the aircraft, such as a leading edge.

Moreover, the de-icing element 1 includes at least one excitation actuator 5 fixed to the skin 2. As represented in FIGS. 1 to 7, the excitation actuator 5 may be fixed to a rear surface 6 opposite the surface 3 to be de-iced. The rear surface 6 preferably corresponds to a face of the de-icing element 1 that is protected from the formation of ice.

The excitation actuator 5 may correspond to an actuator of electromechanical type. It is configured to excite the skin 2 in at least one predetermined vibration mode. The action of “exciting” the skin 2 preferably consists in applying sustained mechanical loads to said skin 2 in order to cause it to vibrate. However, it may equally apply shocks to the skin 2 or cause it to be subjected to pulsed forces. The excitation actuator 5 may therefore be configured to excite the skin 2 by vibrations, by shocks or by pulsed forces.

Moreover, one vibration mode of the skin 2 corresponds to a characteristic form of deformations suffered by the skin 2 when it is excited by a given excitation. Particular vibration modes of the skin 2 are represented in FIG. 2 and in FIGS. 10 to 14. They are formed by antinodes 7 (represented by dark areas) and by nodes 8 (represented by light areas). The antinodes 7 correspond to zones of the skin 2 with deformations and the nodes 8 to zones without deformations. The deformations caused by the vibration mode or modes of the skin 2 makes it possible to break up the layer 4 of ice. In particular, it enables cracks to be created in the layer 4 of ice leading to de-icing of the surface 3 to be de-iced of the de-icing element 1.

The excitation actuator 5 may be a standard electromechanical actuator using varied technologies to drive the excitation of the skin 2. The excitation actuator 5 is preferably a piezoelectric-type actuator, for example composite actuators or multilayer ceramic actuators, or prestressed transducers. However, it may equally be an actuator of electromechanical type, for example an acoustic coil actuator.

In a manner that is not limiting, the characteristic thickness E of the skin 2 is between 0.5 mm and 5 mm. Moreover, by way of non-limiting example, the skin 2 may be made of metal material, for example of aluminum, or of composite material. A skin 2 is therefore obtained the flexibility of which enables the excitation actuator 5, via a low-loading force and a low consumption of electrical power, to induce deformations of said skin 2 sufficient to de-ice the surface 3 to be de-iced.

Moreover, the skin 2 features local variations of thickness 9 that are localized as a function of the predetermined vibration mode or modes. The variations of thickness 9 are in particular localized in a specific manner in order to optimize the deformations of the predetermined vibration mode or modes, as described hereinafter. The effect of this specific localization of the thickness variations 9 is to maximize the efficacy of the deformations of the skin 2 to break up and/or to create cracks in the layer 4 of ice.

Moreover, the predetermined vibration mode or modes correspond to vibration modes of the skin chosen in preliminary studies. Indeed, the vibration modes of the skin 2 depend on its geometry, the materials from which it is made and the conditions at its limits, in particular how it is fixed at its ends. As a function of these criteria the skin 2 has specific vibration modes that should be identified in order to determine those of interest. The vibration modes of the skin 2 may be identified by digital simulation, for example using finite element methods. However, they may also be identified empirically.

The predetermined vibration mode or modes are chosen from the vibration modes identified during the preliminary studies. They are preferably vibration modes the deformations of which make it possible to cover the greatest possible area of the skin 3. The choice of a plurality of vibration modes in particular makes it possible to target deformations covering all or almost all of the surface 3 to be de-iced.

The thickness variations 9 are localized on the skin 2 as a function of the predetermined modes in such a manner as to render uniform the deformations of the skin 2 at the level of the antinode or antinodes 7. By “to render uniform the vibrations” is meant to improve the distribution of said deformations over the whole of the skin 2.

Indeed, for a usual skin with a constant thickness, the energy of elastic deformation generated by a deformation of said skin is not uniform. In particular, when such skin is excited, it has an elastic deformation energy at the antinodes which is maximum at the antinodes and which is null at the nodes. This generates a highly variable rate of elastic energy release, which is detrimental for the adhesive fracturing of the ice.

The variation of thicknesses 9 makes it possible to obtain, in particular, resonance bending modes, uniformizing the deformations and thus the energy distribution fields of elastic deformation in the ice facilitating the process of delamination.

This rendering uniform of the deformations has a number of consequences.

Firstly, rendering the deformations of the skin 2 uniform makes it possible to render uniform the energy transmissible by said skin 2 to the layer 4 of ice. Indeed, rendering uniform the deformation renders uniform the curvatures that are zones of high stresses and therefore of high energy concentration. Accordingly, rendering the curvature uniform makes it possible to render uniform the deformation elastic energy present in the ice at the level of the antinodes 7. Consequently, by rendering uniform the curvatures during deformation of the skin 2, the thickness variations 9 make it possible to render uniform the energy transmissible by said skin 2 to the layer 4 of ice. This energy is responsible for de-icing the surface 3 to be de-iced. It is particularly suitable for enlarging the area of delamination of the layer 4 of ice.

Secondly, rendering uniform the curvature of the deformation of the skin 2 makes it possible to increase and to render uniform the energy release to the surface 3 to be de-iced. Now, the energy release characterizes the capacity to transmit energy and in particular the capacity to propagate cracks. Consequently, the thickness variations 9 make it possible to amplify the transfer of energy from the skin 2 to the layer 4 of ice, in particular to optimize the propagation of cracks in the layer 4 of ice. This can in particular make it possible to propagate cracks more effectively if the surface 3 to be de-iced carries a plurality of layers 4 of ice superposed on one another.

Thirdly, rendering uniform the deformations of the skin 2 makes it possible to enlarge the curvature areas of said skin 2. Enlarging the curvature areas enables improved distribution of energy over the surface 3 to be de-iced and therefore increases the area of the skin 2 effectively protected against ice.

Moreover, the vibration modes of the skin 2 depend on the distribution of weight and quadratic moments (linked to the geometry) of said skin 2. It is possible to influence the vibration modes by varying these parameters, for example in order to obtain a vibration mode specific to a preferred excitation.

Indeed, the energy density transmitted by the skin 2 to the ice depends on the mechanical stress in the skin 2 during its deformation. This elastic energy density is calculated from the following equation:

$${W}_{e} = \frac{1}{2} \frac{{σ}^{2}}{E}$$

in which:
σ is the mechanical stress in the skin; and
E is the Young's modulus of the skin.

For a given bending moment M_{f}, this mechanical stress is calculated from the following equation:

$$σ = \frac{{M}_{f}}{I} y$$

in which:
I is the quadratic moment of the skin; and
y is the position in relation to the neutral axis (the line passing through the gravity center of the cross sections of the skin according to the cutting plane considered).

The quadratic moment I strongly depends on the thickness of the skin since it is calculated from the following equation:

$$T = \frac{{bh}^{3}}{12}$$

in which:
b is the depth of the skin (depending on the cutting plane considered); and
h is the thickness of the skin.

Therefore, by choosing a specific thickness in particular locations, it is possible to obtain more or less elastic energy during deformation of the skin.

Another method for varying these parameters may include optimizing the topology of the skin 2, for example by creating zones with no material in the skin 2. Such optimization can easily be obtained, in particular by 3D printing. Another method for varying these parameters may include producing the skin 2 using different materials, for example by combining metal material and composite material, or using so-called “sandwich” materials. A sandwich material comprises two thin and rigid external layers between which is a lightweight and thick internal core, such as a honeycomb core.

The predetermined vibration modes preferably correspond to resonance modes of the skin 2. The resonance modes are vibration modes particularly suitable for de-icing since they enable maximum deformations of the skin 2 to be obtained. This makes it possible to optimize the effectiveness of the de-icing of the surface 3 to be de-iced.

Moreover, as represented in FIG. 1 and FIG. 2, the thickness variations 9 of the skin 2 are preferably localized at the level of the antinodes 7 of the predetermined vibration mode or modes.

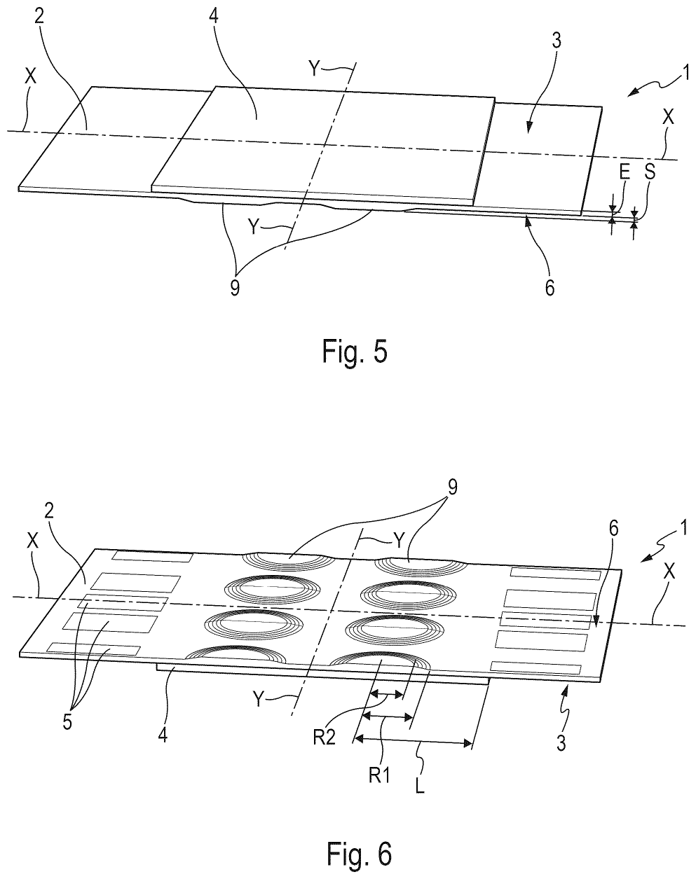

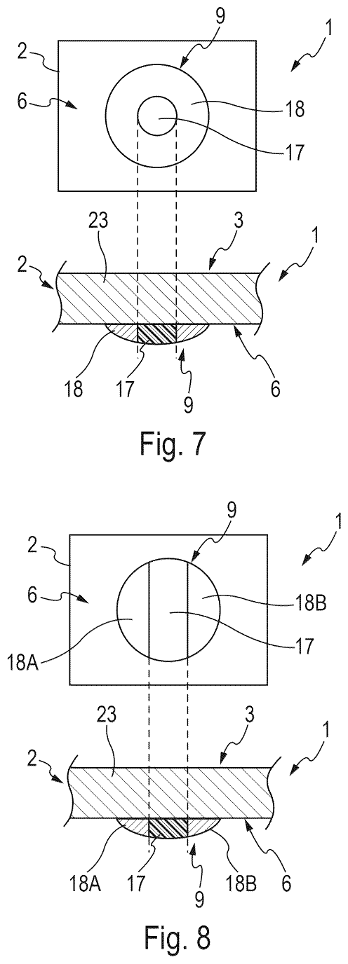

In a particular embodiment represented in FIG. 1, FIG. 2 and FIGS. 5 to 8, the thickness variations 9 of the skin 2 correspond to increases in the thickness of the skin 2. These thickness increases can be produced directly in the shape of the skin 2. They may in particular be bosses as shown in FIG. 1 or in FIG. 7 and FIG. 8. A boss corresponds to a projection of material having a linear contour able to assume varied shapes. However, an overthickness may equally take other forms, for example a staggered projection of material (with a non-linear contour) as represented in FIG. 5 and FIG. 6.

Moreover, in another embodiment represented in FIG. 7 and FIG. 8, the thickness increases of the skin 2 (the bosses in this case) are produced by attached parts. The skin 2 includes a main layer 23 the thickness of which is equal to the characteristic thickness E. The attached parts producing the thickness increases are fixed to the main layer 23 at the level of the surface 6 opposite the surface 3 to be de-iced. They may be fixed in a standard manner, for example glued on. The parts attached to the main layer 23 of the skin 2 correspond to the thickness variations 9. They enable localized increase of the thickness of the skin 2 in a simple, relatively low cost and adaptable manner.

In one particular implementation of one of the above embodiments, the thickness increases of the skin 2 take the form of bosses. As represented in particular examples in FIG. 7 and FIG. 8, each of these bosses comprises a central part 17 and a peripheral part 18. The central part 17 corresponds to where the thickness of the skin 2 is maximal. The central part 17 is surrounded by a peripheral part 18, 18A, 18B. The central part 17 and the peripheral part 18, 18A, 18B may be arranged in varied ways. For example, as represented in FIG. 7, the peripheral part 18 may completely surround the central part 17 in the circumferential direction. In another example, represented in FIG. 8, the peripheral part 18A, 18B may partly surround the central part 17 on the flanks. In this case the peripheral part 18A, 18B may take the form of two elements extending longitudinally on each side of the central part 17. Moreover, the central part 17 has a higher stiffness than the peripheral part 18, 18A, 18B. For example, the central part 17 may be made of a stiffer material than the peripheral part 18, 18A, 18B. This stiffness difference enables further optimization of the deformations of the skin 2 when it is excited by the actuators 5.

In another embodiment represented in FIG. 3 and FIG. 4, the thickness variations 9 correspond to local reductions of the thickness of the skin 2 relative to the characteristic thickness E. Each of the thickness reductions includes in particular a bottom 19 where the thickness of the skin 2 is minimal.

In one particular implementation of this embodiment represented in FIG. 3 the thickness reductions correspond to curved cavities. These cavities have in particular a rounded hollow shape within the thickness of the skin 2. Moreover, the skin includes a rigid part 20 in line with the bottoms 19 of its cavities. The rigid part 20 has a higher stiffness than the rest of the skin 2. This stiffness difference enables further optimization of the deformations of the skin 2 when it is excited by the actuators 5.

In another particular implementation of this embodiment represented in FIG. 4, the element 1 includes a membrane 21. The membrane 21 is arranged on the skin 2 in such a manner as to espouse the shape of the thickness reductions (in this case the cavities). Moreover, at the level of each bottom 19, the membrane 21 has a concave edge 22. These concave edges 22 have a higher stiffness than the rest of the membrane 21. This stiffness difference enables further optimization of the deformations of the skin 2 when it is excited by the actuators 5. For example, the membrane 21 is arranged to the skin 2 by gluing.

Moreover, as represented in particular embodiments in FIG. 1 and FIGS. 3 to 5 and in a manner that is not limiting, the thickness variations 9 of the skin 2 have a characteristic size between 30% and 80% of the characteristic thickness E of the skin 2. In particular, the thickness increases have a maximum thickness S between 30% and 80% of the characteristic thickness of the skin 2. The thickness increases have a maximum depth P between 30% and 80% of the characteristic thickness of the skin 2. The maximum thickness S or the maximum depth P are preferably equal to 50% of the characteristic thickness E of the skin 2.

Three particular embodiments are represented in FIGS. 1 to 11.

A first embodiment enabling a good understanding of the principle of the invention in one dimension to be obtained is represented in FIGS. 1 to 4. In these examples the de-icing element 1 includes a skin 2 having a rectangular blade shape the greater length of which defines a longitudinal direction of the skin 2. The skin 2 is fixed at its longitudinal ends by build-in type connections. The de-icing element 1 also includes two excitation actuators 5 arranged at respective opposite longitudinal ends of the skin 2.

The excitation actuators 5 are configured to cause the skin 2 to vibrate in a predetermined vibration mode represented in FIG. 2. This predetermined vibration mode has been chosen beforehand as described above and corresponds to a usual bending mode of the skin 2 in one dimension, namely in the longitudinal direction of the blade forming the skin 2. The bending mode comprises three antinodes 7 and five nodes 8. The two nodes 8 at the longitudinal ends of the skin 2 correspond to where said skin 2 is built in.

Knowing the shape of the bending mode chosen and therefore the location of the antinodes 7, thickness variations 9 have been produced on the rear surface 6 of the skin 2 at the design stage. In the example from FIG. 1 and FIG. 2, the thickness variations 9 correspond to bosses. In these figures, the skin 2 includes three bosses at the level of the zones in which three antinodes 7 are formed when the skin 2 is excited by the excitation actuators 5. Thanks to these bosses, a skin 2 is obtained the deformations of which are rendered uniform as described above. Locating the bosses at the level of the antinodes 7 in particular enables distribution of energy release over larger areas around areas of high curvature (namely the crests of the antinodes 7) and therefore extension of the effective area de-iced.

In the example from FIG. 3 and FIG. 4, the thickness variations 9 correspond to cavities. This variant embodiment enables the same effects to be obtained as bosses with regard to the deformations of the skin 2. It therefore enables the same effectiveness to be achieved in de-icing the surface 3 to be de-iced of the skin 2.

A second embodiment enabling a good understanding of the principle of the invention in two dimensions to be obtained is represented in FIG. 5 and in FIG. 6. In this example, the de-icing element 1 includes a skin 2 of plate shape having a longitudinal direction represented by an axis X-X and a transverse direction represented by an axis Y-Y. The de-icing element 1 also includes a plurality of excitation actuators 5 arranged symmetrically at the level of the longitudinal ends of the skin 2.

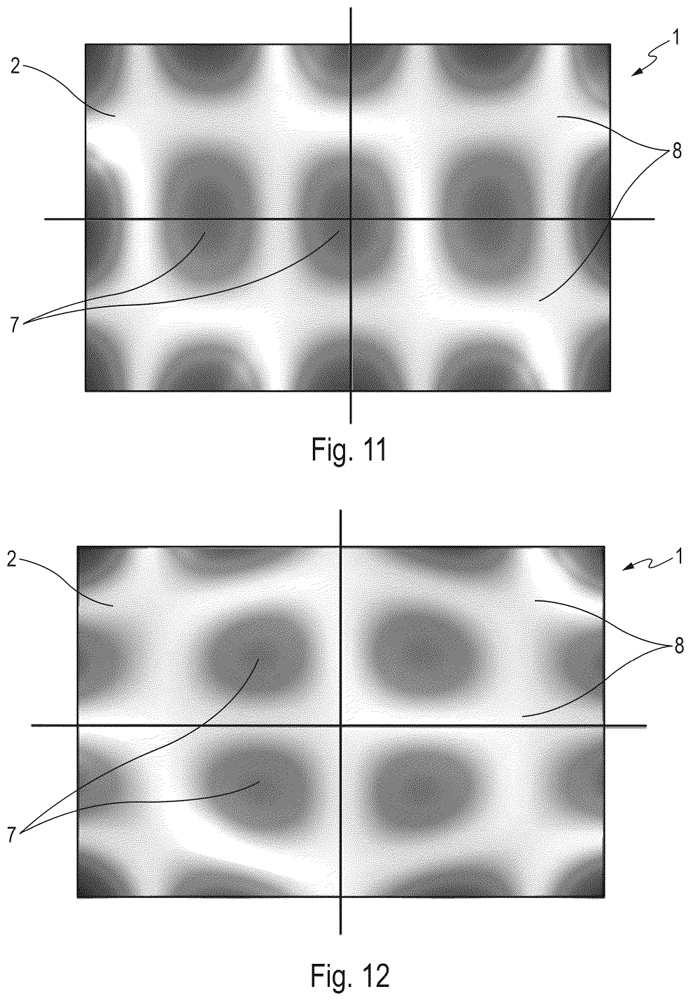

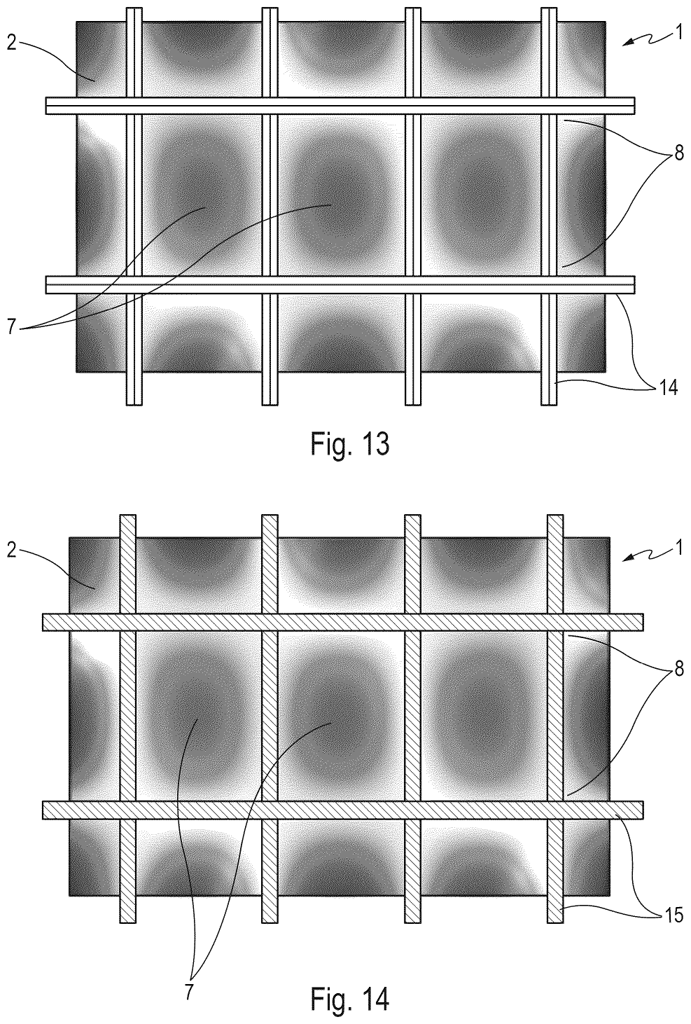

The excitation actuators 5 are configured to cause the skin 2 to vibrate in predetermined vibration modes (not represented). For example, a skin 2 of plate shape vibrating in two possible vibration modes is represented in FIG. 11 and FIG. 12. These examples are not limiting and the predetermined vibration modes may be more numerous and have highly varied shapes as a function of the configuration of the de-icing element 1 (geometry of the plate forming the skin 2, material, conditions at the limits).

The arrangement and the configuration of the excitation actuators 5 make it possible in particular to obtain varied vibration modes. Indeed, by causing the skin 2 to vibrate with the same set point for all of the excitation actuators 5, a certain number of vibration modes can be obtained. However, varied vibration modes can equally be obtained by activating successively some of the excitation actuators 5 and then other excitation actuators 5. Another method enabling varied vibration modes to be obtained can be to drive the excitation actuators 5 with different set points, for example with different polarities.

The skin 2 has a plurality of thickness variations 9 on its rear surface 6. These thickness variations 9 can correspond to bosses. Each boss has a substantially circular shape with a base of radius R1 on the rear surface 6 and a flat truncated crown of radius R2. Moreover, the bosses can be aligned in two columns perpendicular to the longitudinal axis X-X and symmetrical with respect to the transverse axis Y-Y. Each column is arranged so that the center of each boss of a column is at a distance L from the closest longitudinal end of the skin 2. The radii of the bosses preferably vary between 40% and 70% of the distance L. For example, the radius R1 is equal to 70% of the distance L and the radius R2 is equal to 40% of the distance L.

A configuration of the bosses on the skin 2 as described hereinabove makes it possible to obtain optimized uniformity of the deformations of said skin 2 when it is excited by the excitation actuators 5. Indeed, such bosses avoid excessive stiffening of the skin 2 whilst maximizing the area of the skin 2 over which the deformations of said skin 2 are distributed, rendering de-icing more effective.

A third embodiment illustrating a preferred application of the invention is represented in FIG. 9 and in FIG. 10. In this example, the de-icing element 1 corresponds to a leading edge of an engine nacelle air intake 10. To be more specific, the leading edge, represented schematically in section in FIG. 9, includes a skin 2 in the form of an annular lip. This lip covers the contour of the air intake 10 at a front end 11. The de-icing element 1 also includes a plurality of excitation actuators 5 arranged at the level of a rear end 12 of the skin 2. The rear end 12 is fixed to the front end 11 of the air intake 10.

The excitation actuators 5 are configured to cause the skin 2 to vibrate in varied predetermined vibration modes. A preferred predetermined vibration mode for such a skin 2 is shown in FIG. 10, which represents a portion of said skin 2 in the form of a lip.

Moreover, thickness variations 9 corresponding to bosses are produced on the skin 2. These bosses are localized as a function of the predetermined vibration modes as described above. They are produced on the rear surface 6 of the skin 2 defining an interior space 13 that is oriented toward the interior of the structure of the air intake 10. The surface 3 to be de-iced of the skin 2 is therefore smooth when the skin 2 is not excited by the excitation actuators 5, favoring the aerodynamic properties of the aircraft element 1.

Moreover, variant embodiments represented in FIG. 11 to FIG. 14 enable further optimization of the de-icing of the skin 2 of the de-icing element 1.

In a first variant embodiment represented in FIG. 11 and FIG. 12, the excitation actuator 5 of the de-icing element 1 is configured to excite the skin 2 successively in two predetermined vibration modes that are complementary in terms of deformation and stress. In FIG. 11 and FIG. 12, the skin 2 is of plate form but the principle of complementary vibration modes is not limited to this skin geometry and can be applied to a skin 2 of any shape. The excitation actuator 5 is configured to cause the skin 2 to vibrate successively and repeatedly (or cyclically) in a so-called “symmetrical” first vibration mode (FIG. 11) and then in a so-called “antisymmetrical” second vibration mode that is complementary to the first vibration mode (FIG. 12).

As described above, thickness variations 9 (not represented in FIGS. 11 and 12) are produced on the skin 2 as a function of the symmetrical and antisymmetrical vibration modes.

Moreover, these two vibration modes are complementary in terms of deformation in that the antinodes 7 of the one are localized at the locations of the nodes 8 of the other and vice versa. This complementarity between the two vibration modes makes it possible to obtain deformations of the skin 2 distributed over the whole of the surface 3 to be de-iced. However, the complementarity of the predetermined vibration modes may also relate to the mechanical stresses in the skin 2 when it is excited. For example, two vibration modes may be complementary in terms of stress in that the areas in which the stresses in one are highest correspond to the areas in which the stresses in the other are lowest.

In a second variant embodiment represented in FIG. 13 the de-icing element 1 includes heat strips 14 on the surface 3 to be de-iced of the skin 2. The heat strips 14 are fixed at the level of the nodes 8 of the predetermined vibration mode considered in this embodiment. The heat strips 14 are in particular configured to generate heat adapted to reduce adhesion or to de-ice the surface 3 to be de-iced near the nodes 8 on which they are arranged.

The heat strips 14 enable de-icing of the skin 2 to be assisted by causing the layer 4 of ice to melt, at least partly, at the level of the nodes 8 on which they are fixed. The layer 4 of ice melted in this way or heated is then easier to break up at the level of the nodes 8 via the deformations of the skin 2 excited by the excitation actuator 5. The heat strips 14 therefore make it possible to render the de-icing of the skin 2 even more effective.

The heat strips 14 may be standard heating devices using electrical resistance elements. They may be fixed to skin 2 in the usual way, for example glued to it.

In a third variant embodiment represented in FIG. 14 the de-icing element 1 includes elastic strips 15 on the skin 2. The elastic strips 15 are fixed at the level of the nodes 8 of the predetermined vibration mode considered in this example. The elastic strips 15 are in particular adapted to induce a local variation of stiffness of the skin 2. For example, the elastic strips 15 may be flexible strips in order locally to render flexible the skin 2. Locally rendering the skin 2 flexible means that at the level of the nodes 8, the stiffness is lower than the mean stiffness of the complete skin 2. However, in other situations the elastic strips 15 may instead correspond to rigid strips adapted to stiffen the skin 2 locally. Stiffening the skin 2 locally means that at the level of the nodes 8 the stiffness is higher than the mean stiffness of the complete skin 2.

The elastic strips 15 enable de-icing of the skin 2 to be assisted by encouraging shear stresses at the level of the nodes 8 on which they are fixed. Indeed, during deformation of the skin 2 by the excitation actuator 5, the nodes 8 are stressed in shear. The elastic strips 15 make it possible to accentuate these shear stresses in order to favor the commencement of rupture in the layer 4 of ice at the level of the nodes 8. The elastic strips 15 therefore make it possible to render the de-icing of the skin 2 even more effective.

In a complementary fourth embodiment represented in FIG. 1, the de-icing element 1 includes on this surface 3 to be de-iced of the skin 2 an ice-resistant coating 16. The ice-resistant coating 16 corresponds to a coating layer applied to the surface 3 to be de-iced adapted to reduce the adhesion of the layer 4 of ice to said surface 3 to be de-iced. The ice-resistant coating 16 therefore makes it possible to render the de-icing of the skin 2 even more effective.

Moreover, the de-icing element 1 may be a part of the aircraft AC, as described above. As represented in FIG. 15, the de-icing element 1 of the aircraft AC corresponds to a leading edge of an engine nacelle air intake of said aircraft AC. However, the aircraft AC may equally include de-icing elements 1 corresponding to varied elements. For example, these may be leading edges of wings or control surfaces.

The de-icing element 1 comprising the skin 2 that can be excited by the excited actuator 5 as described hereinabove has numerous advantages. In particular:
it makes it possible to obtain a surface 3 to be de-iced that can be de-iced by mechanical excitation of the skin 2;
it makes it possible to improve the de-icing of the surface 3 to be de-iced by rendering uniform the deformations of the skin 2 and amplifying the impact of the actuator on the layer 4 of ice;
it makes it possible to increase the effectiveness of de-icing by enlarging the areas of effective deformation of the skin 2;
it makes it possible to obtain de-icing of a surface thanks to mechanical loading with low consumption of electrical energy;
it enables parts of an aircraft to be protected against the formation of ice by providing a de-icing surface.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A de-icing element comprising:
a skin having a surface to be de-iced, and,
at least one excitation actuator fixed to the skin, the excitation actuator configured to excite the skin in at least one predetermined vibration mode generating a deformation of the skin, the deformation of the skin including at least one antinode and one node,
wherein the skin has a characteristic thickness that is generally constant with at least one local thickness variation that is localized according to the at least one predetermined vibration mode.

2. The de-icing element according to claim 1, wherein the at least one predetermined vibration mode comprises a resonance mode of the skin.

3. The de-icing element according to claim 1, wherein the at least one local thickness variation is localized at a level of the at least one antinode of the at least one predetermined vibration mode.

4. The de-icing element according to claim 1, wherein the at least one local thickness variation of the skin corresponds to an increase in a thickness of said skin relative to the characteristic thickness.

5. The de-icing element according to claim 4, wherein the increase in the thickness corresponds has a boss shape comprising a central part in which the thickness of the skin is maximal and a peripheral part surrounding the central part, the central part having a greater stiffness than a stiffness of the peripheral part.

6. The de-icing element according to claim 1, wherein the skin further comprises:
a main layer having a thickness equal to the characteristic thickness, and
one or more attached parts fixed to the main layer, the one or more attached parts corresponding to the at least one local thickness variation of the skin.

7. The de-icing element according to claim 6, wherein the at least one local thickness variation of the skin has a boss shape comprising a central part in which the thickness of the skin is maximal and a peripheral part surrounding the central part, the central part having a greater stiffness than a stiffness of the peripheral part.

8. The de-icing element according to claim 1, wherein the least one local thickness variation correspond to a local thickness reduction of said skin relative to the characteristic thickness, said local thickness reduction comprising a bottom where the thickness of the skin is minimal.

9. The de-icing element according to claim 1, wherein the excitation actuator is configured to excite the skin successively in at least two predetermined vibration modes, said at least two predetermined vibration modes being complementary in terms of deformation and stress.

10. The de-icing element according to claim 1, further comprising:
at least one heat strip fixed to the skin at a level of at least one node of the predetermined vibration mode,
said heat strip being configured to generate heat for de-icing the surface to be de-iced of the skin at least at the level of the at least one node on which said heat strip is fixed.

11. The de-icing element according to claim 1, wherein the excitation actuator comprises to an electromagnetic actuator or a piezoelectric actuator.

12. The de-icing element according to claim 1, wherein the excitation actuator is configured to excite the skin by vibrations, by shocks, or by pulsed forces.
